(19) United States
(12) Patent Application Publication
(10) Pub. No.: US 2019/0243515 A1
(43) Pub. Date: Aug. 8, 2019

(54) Invoke a Service in an Electronic Document Using a Trigger Entry

(71) Applicant: Microsoft Technology Licensing, LLC, Redmond, WA (US)

(72) Inventors: Catherine Anne HARLEY, Seattle, WA (US); Yibing ZHU, Woodinville, WA (US); Victor POZNANSKI, Sammamish, WA (US); Derik Bjorn STENERSON, Redmond, WA (US)

(73) Assignee: Microsoft Technology Licensing, LLC, Redmond, WA (US)

(21) Appl. No.: 15/891,347

(22) Filed: Feb. 7, 2018

(51) Int. Cl. G06F 3/0482; G06F 17/24

(52) U.S. Cl. CPC G06F 3/0482; G06F 17/243

(57) ABSTRACT

Described herein is a system and method for invoking a service using a trigger entry. During editing of a document, a trigger entry that is based upon content added to the document is received. Responsive to receipt of the trigger entry, information regarding one or more services (e.g., local and/or remote) is provided with selection of a service received from a user. The selected service is then invoked with information from the selected service provided to the user and/or information received from the user provided to the selected service (e.g., in real-time).

### BACKGROUND

Word processing, spreadsheet, database, slide presentation, electronic mail, drawing, note taking, web browser, media player, and game applications allow users to view, create, and/or edit documents. However, as information relevant to a document changes, the document conventionally is required to be manually updated with corresponding information in order to remain current and relevant. Additionally, conventional methods of interacting with applications have involved a user learning a combination of keystrokes and/or leaving a document canvas to navigate graphical user interfaces.

### SUMMARY

Described herein is a system for invoking a service using a trigger entry, comprising: a computer comprising a processor and a memory having computer-executable instructions stored thereupon which, when executed by the processor, cause the computing device to: during editing of a document, receive a trigger entry, wherein the trigger entry is based upon content added to the document; responsive to receipt of the trigger entry, provide information regarding one or more services; receive selection of a service from a user; and invoke the selected service.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a system for invoking a service using a trigger entry.

FIG. 2 is a diagram illustrating an exemplary user interface.

FIG. 3 is a diagram illustrating an exemplary user interface.

FIG. 4 is a diagram illustrating an exemplary user interface.

FIG. 5 is a diagram illustrating an exemplary user interface.

FIG. 6 illustrates an exemplary method for invoking a service using a trigger entry.

FIG. 7 is a functional block diagram that illustrates an exemplary computing system.

### DETAILED DESCRIPTION

Various technologies pertaining to invoking a service using a trigger entry in an electronic document are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding invoking a service using a trigger entry in an electronic document. What follows are one or more exemplary systems and methods.

Aspects of the subject disclosure pertain to the technical problem of invoking a service while editing an electronic document. The technical features associated with addressing this problem involve during editing of an electronic document, receiving a trigger entry. Responsive to receipt of the trigger entry, information regarding one or more services is displayed. In response to a user selection of a service, information regarding the selected service is displayed. Accordingly, aspects of these technical features exhibit technical effects of more efficiently and effectively increasing user efficiency and/or reducing network bandwidth, as users can obtain information in a more efficient manner.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

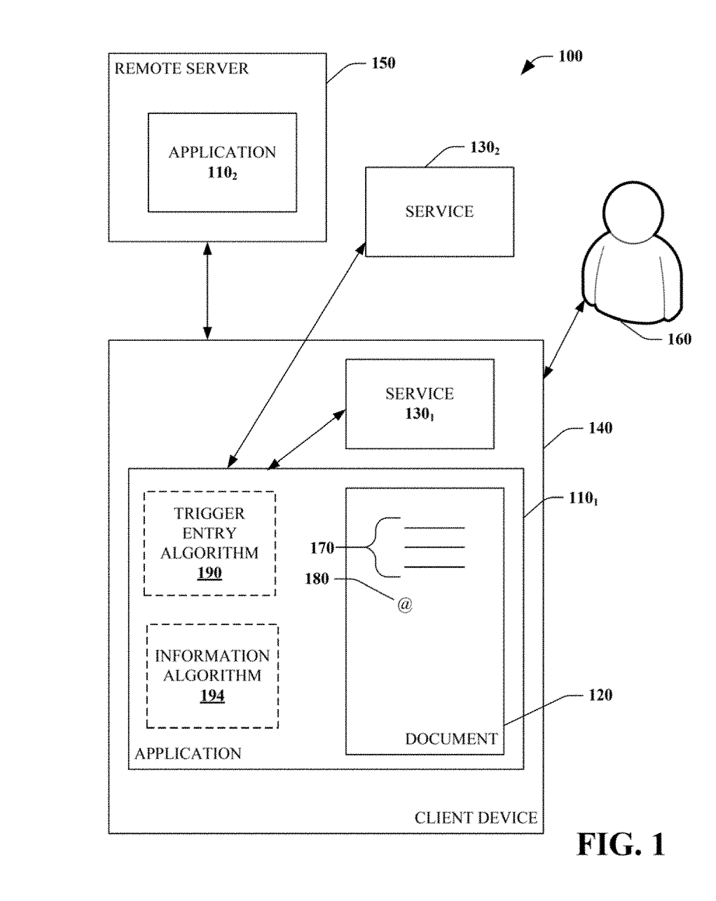

Referring to FIG. 1, a system for invoking a service using a trigger entry 100 is illustrated. The system 100 includes an application 110₁, 110₂ (generally, 110) used to view, generate, and/or edit an electronic document 120. Examples of suitable applications 110 include, but are not limited to, word processing, spreadsheet, database, slide presentation, electronic mail, drawing, note taking, web browser, media player, and game applications.

The system 100 can facilitate a user's interaction with one or more services 130 without exiting the application 110, minimizing the application 110 and/or leaving a document canvas of an electronic document 120 associated with the application 110.

In some embodiments, the application 110₁ is a thick client application stored locally on a client device 140. In some embodiments, the application 110₂ is thin client application (i.e., web applications) that resides on a remote service 150 and accessible over a network or combination of networks (e.g., the Internet, wide area networks, local area networks). A thin client application 110₂ can be hosted in a browser-controlled environment or coded in a browser-supported language and reliant on a common web browser to render the application executable on the client device 140.

A user 160 can use the application 110 to create a new document 120, edit an existing document 120, and/or view an existing document 120. The application 110 receives input from the user 160, for example, text input, from one or more input devices including, for example, a keyboard, a computer mouse, a remote control. In some embodiments, the application 110 receives input from the user 160 through a Natural User Interface (NUI) which enables the user to interact with the client device 140 in a natural manner. Examples of NUI include speech recognition, touch and stylus recognition, gesture recognition both on screen and adjacent to the screen, air gestures, head and eye tracking, voice and speech, vision, touch, hover, gestures, machine intelligence, and the like.

The user input results in content 170 being added to the document 120. In some embodiments, content 170 is added within a document canvas (e.g., a page in a word processing document, a spreadsheet in a spreadsheet document, a slide in a presentation document) of the document 120.

During editing of the document 120, the application 110 can monitor a user's interaction with the document 120 to determine when a trigger entry 180 has been received. In some embodiments, the trigger entry 180 is based upon content added to the document 120.

In some embodiments, the trigger entry 180 corresponds to an inline command to provide information regarding one or more services 130 without exiting the application 110, minimizing the application 110, and/or leaving a document canvas of the document 120 associated with the application 110. In some embodiments, the trigger entry 180 is “@”. Upon receiving the “@”, the application 110 can determine that a trigger entry 180 has been received. The trigger entry 180 of “@” is just one example, and other character(s), symbol(s), and/or sequence(s) of character(s) and/or symbol(s) can be used as trigger entry(ies) 180.

In some embodiments, the trigger entry 180 is inferred based upon an analysis of content 170 as it is being added to the document. The analysis can be performed based on a trigger entry algorithm 190 which the application 110 employs to analyze content 170 and/or format of content 170 entered by the user 160 to infer the trigger entry 180.

In some embodiments, the trigger entry algorithm 190 can be probabilistic. A probability that the user 160 is at a location in the document 120 that the user 160 would likely desire to invoke one or more services 130 is calculated (e.g., based upon an analysis of content 170 and/or format of content 170). Based upon a calculated probability equal to or greater than a predetermined threshold, the application 110 can infer that a user likely desires to invoke one or more services 130. By way of example, and not limitation, as the user 160 enters content 170 having the words “invoice”, “amount due” with a monetary value, the application 110 can infer that the user 160 would likely desire to invoke one or more services 130 (e.g., a payment service) and thus that the trigger entry 180 has been received. By way of example, and not limitation, as the user 160 enters content 170 having a particular format, the application 110 can infer the user 160 would likely desire to invoke one or more services 130 and that the trigger entry 180 has been received.

In some embodiments, the trigger entry algorithm 190 is adaptively updated based upon action(s) taken and/or not taken by the user 160 (e.g., inferred trigger entry 180 ignored by user 160) in response to services 130 suggested and/or particular content 170. In this manner, inferred trigger entry(ies) 180 can be more accurate and personalized to the particular user 160.

Responsive to receipt of the trigger entry 180, the application 110 can provide information regarding one or more services 130 available to the user 160. In some embodiments, the information is provided to the user 160 via a display. In some embodiments, the information is provided to the user 160 via a speaker of the client device 140.

In some embodiments, one or more of the services 130 are local to the client device 140. In some embodiments, one or more of the services 130 are hosted remotely and accessible to the client device 140, for example, via the Internet, a wide area network and/or a local area networks. In some embodiments, one or more of the services 130 comprise a bot assistant.

In some embodiments, the information provided regarding the one or more services 130 can be determined by the application 110 based upon a context associated with the document 120. For example, the application 110 can determine the context based upon content of the document 120, a file name associated with the document 120, metadata associated with the document 120 and the like.

In some embodiments, the information provided regarding the one or more services 130 can be determined based upon stored historical usage of a particular user 160 of the application 110. For example, service(s) 130 which the particular user 160 has used can be ranked and presented in an ordered list of descending usage.

In some embodiments, the information provided regarding the one or more services 130 can be determined by an information algorithm 194 of the application 110 that stores information regarding previous trigger entries 180, contextual information regarding documents 120 associated with the previous trigger entries 180, and/or received user responses (e.g., services 130 selected) in response to the previous trigger entries 180. Using the stored information, the information algorithm 194 can analyze at least some content 170 and/or format of content 170 of a document 120 to determine information provided regarding the one or more services (e.g., suggested services 130). Thus, the application 110 can utilize context (e.g., content 170 and/or formatting of content 170) surrounding a trigger entry 180, and user action(s) in response (e.g., selected service(s) 130) to adaptively provide information (e.g., suggestions) to the user 160. In this manner, the information (e.g., suggestions) can be more accurate and personalized to the particular user 160.

In some embodiments, the trigger entry 180 can be accompanied by one or more additional character(s) and/or symbol(s) which the application 110 can utilize to determine which service(s) 130 to include in the information provided regarding the one or more services 130.

In some embodiments, the information provided regarding the one or more services 130 can be an intelligent list. The intelligent list can be populated with information regarding services 130 based upon historical usage of a particular user, historical usage of a plurality of users (e.g., provided to the application 110 in a privacy-preserving manner), and/or a context of the document 120 determined by the application.

In some embodiments, a quantity of services 130 included in the information provided regarding the one or more services 130 can be predetermined. In some embodiments, a quantity of services 130 included in the information provided regarding the one or more services 130 can be determined dynamically, for example, based upon a context of the document 120 and/or historical information regarding service usage by a particular user 160.

The application 110 can receive a user selection of a particular service 130 of the one or more services 130 provided (e.g., displayed). In response to the user selection, the application can invoke the selected service 130.

In some embodiments, the application 110 includes code that facilitates communication of information from one or more services 130 to the application 110. In response to the user selection, the application 110 provides information from the selected service 130 to the user (e.g., real-time information).

In some embodiments, the application 110 includes code that facilitates communication to one or more services 130 from the application 110. In response to the user selection and information received from the user 160, the application 110 provides the received information to the selected service 130 (e.g., real-time information).

In some embodiments, in response to selection of a particular service 130, the application 110 embeds code in the document 120 that facilitates communication of information from the particular service 130 to the application 110. In some embodiments, the application 110 can further embed information regarding zero, one or more parameter(s) for use with the particular service 130.

In some embodiments, in response to selection of a particular service 130, the application 110 embeds code in the document 120 that facilitates communication to the particular service 130 from the application 110. In some embodiments, the application 110 can further embed information regarding zero, one or more parameter(s) for use with the particular service 130.

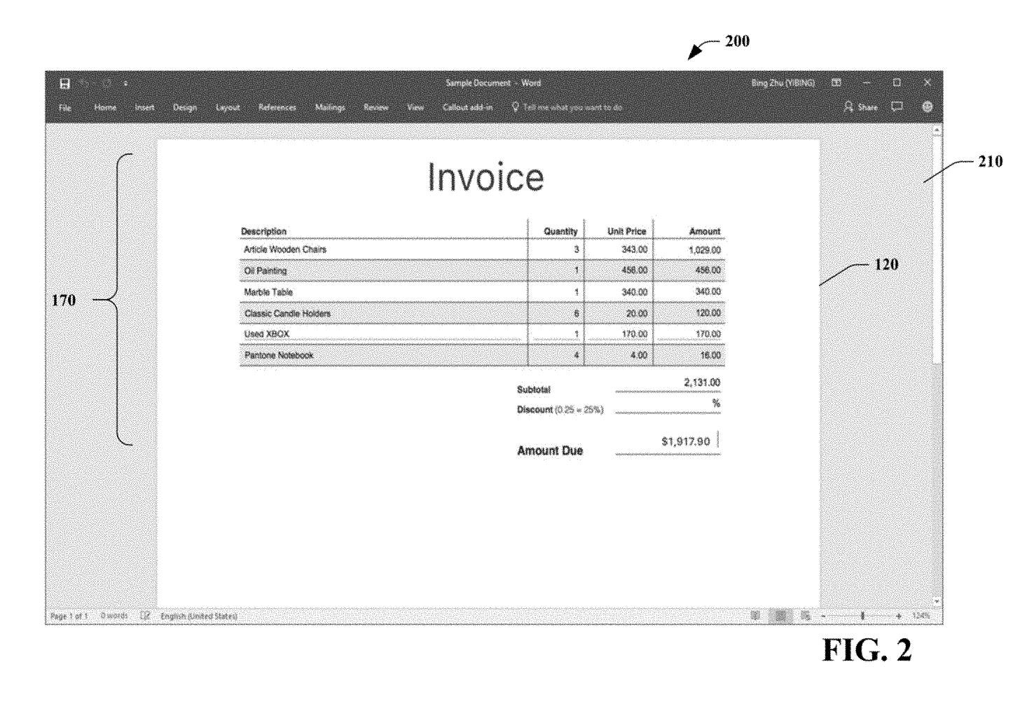

Turning to FIG. 2, an exemplary user interface 200 generated by the application 110 and displayed by the client device 140 is illustrated. A content display area 210 displays content from the document 120. In the example of FIG. 2, a user 160 has placed the cursor to the right of content 170 “$1,917.90”.

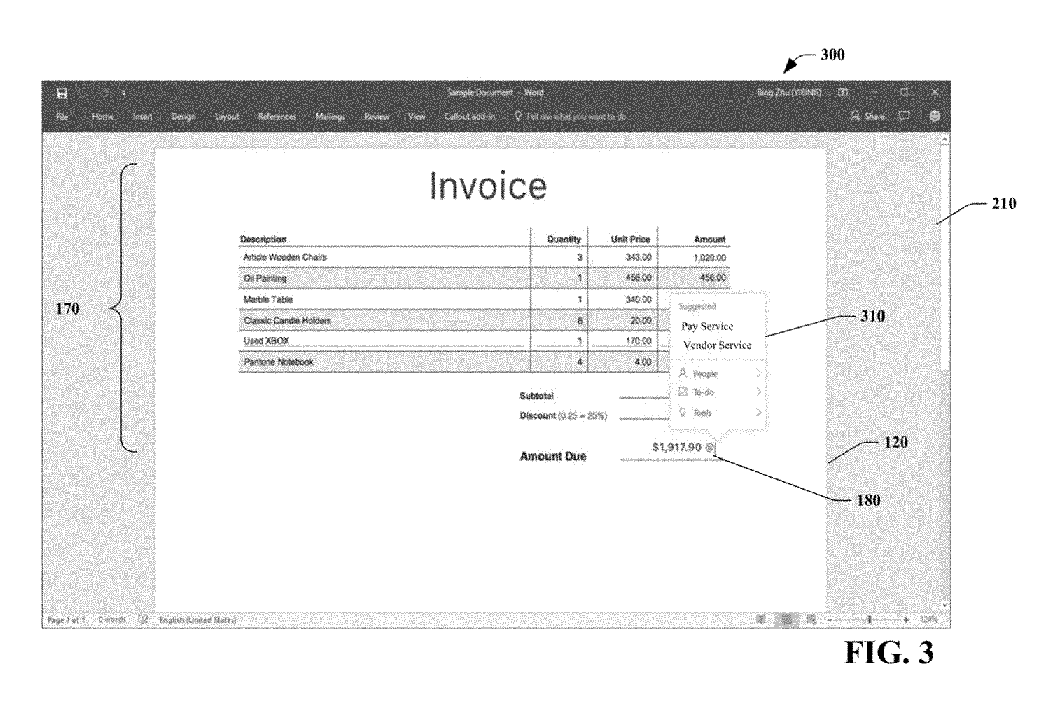

Referring next to FIG. 3, an exemplary user interface 300 generated by the application 110 and displayed by the client device 140 is illustrated. In the example of FIG. 3, the user 160 has entered the trigger entry 180 “@”. Responsive to receipt of the trigger entry 180, the application 110 has provided information regarding one or more services 130 available to the user 160 via a service display area 310.

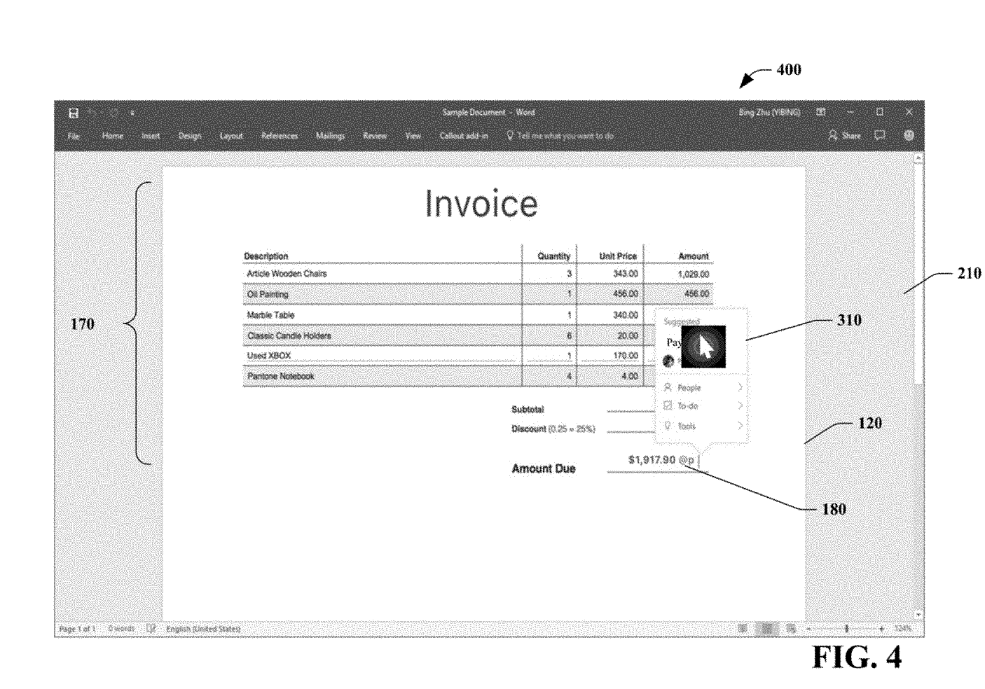

Next, referring to FIG. 4, an exemplary user interface 400 generated by the application 110 and displayed by the client device 140 is illustrated. In the example of FIG. 4, the user 160 has entered additional content 170 “p”. In response to this additional content, the application 110 has provided modified information regarding one or more services 130 available to the user 160 via the service display area 310. In this example, “Paul Smith” has been substituted for “Service 2” based on the entered additional content 170 “p”. Additionally, the user 160 has selected “Pay Service” of the service display area 310.

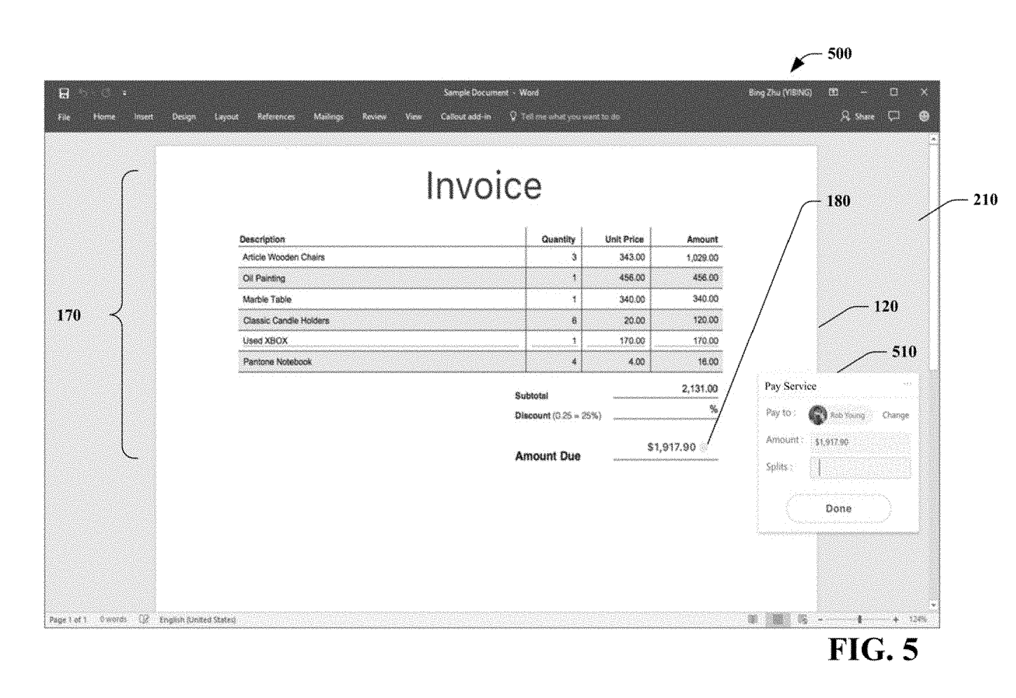

Turning to FIG. 5, an exemplary user interface 500 generated by the application 110 and displayed by the client device 140 is illustrated. In this example, in response to the user selection, the application 110 has invoked the selected service 130, “Pay Service” in this example, causing a service input/output area 510 to be displayed.

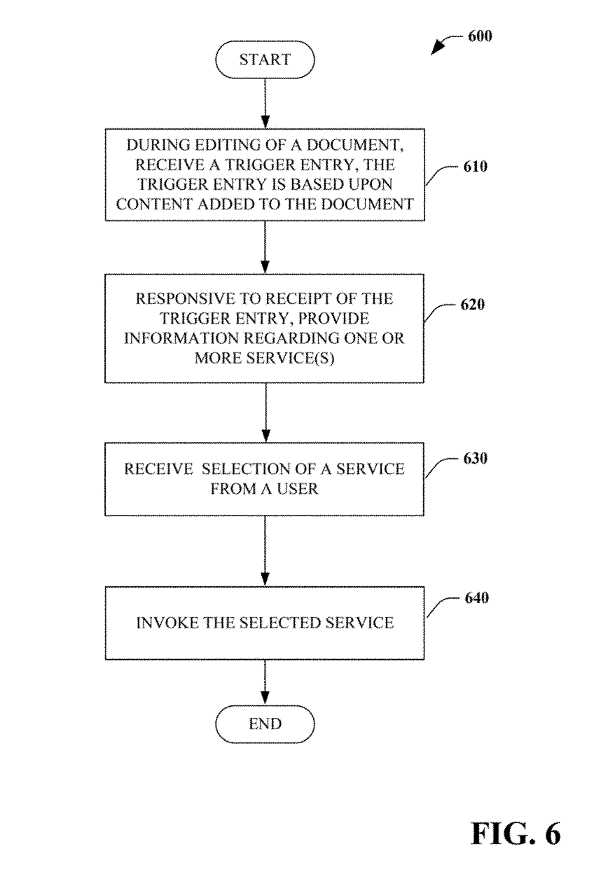

FIG. 6 illustrates an exemplary methodology for invoking a service using a trigger entry. While the methodology is shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 6, a method of invoking a service using a trigger entry 600 is illustrated. In one embodiment, the method 600 is performed by the system 100.

At 610, during editing of a document, a trigger entry is received. The trigger entry is based upon content added to the document (e.g., explicit inline command and/or inferred from content and/or formatting). At 620, responsive to receipt of the trigger entry, information regarding one or more service(s) is provided (e.g., displayed). At 630, selection of a service is received from a user. At 640, the selected service is invoked.

Described herein is a system for invoking a service using a trigger entry, comprising: a computer comprising a processor and a memory having computer-executable instructions stored thereupon which, when executed by the processor, cause the computer to: during editing of a document, receive the trigger entry, wherein the trigger entry is based upon content added to the document; responsive to receipt of the trigger entry, provide information regarding one or more services; receive selection of a service from a user; and invoke the selected service. The system can include wherein invoke the selected service comprises embedding an object into the document, the object comprising code for communicating with the selected service.

The system can further include wherein receive the trigger entry comprises receive a character, symbol, or sequence of characters designed as the trigger entry. The system can include wherein the selected service is invoked by an application associated with the document. The system can further include wherein invoke the selected service comprises an application associated with the document provides information from the selected service to the user.

The system can include herein invoke the selected service comprises an application associated with the document provides information received from the user to the selected service. The system can further include wherein at least one of the one or more services is local to the computer. The system can include wherein at least one of the one or more services is hosted remote from the computer. The system can further include wherein the information provided regarding one or more services is based on at least one of a context of the document, historical information regarding service usage of the user, or historical information regarding service usage of a plurality of users.

Described herein is a method of invoking a service using a trigger entry, comprising: during editing of a document, receiving the trigger entry, wherein the trigger entry is based upon content added to the document; responsive to receipt of the trigger entry, providing information regarding one or more services; receiving selection of a service from a user; and invoking the selected service. The method can include wherein receive the trigger entry comprises receive a character, symbol, or sequence of characters designed as the trigger entry.

The method can further include wherein the selected service is invoked by an application associated with the document. The method can include wherein invoking the selected service comprises the application associated with the document providing information from the selected service to the user. The method can further include wherein invoking the selected service comprises the application associated with the documents providing information received from the user to the selected service.

The method can include wherein at least one of the one or more services is local to a computer executing the application. The method can further include wherein at least one of the one or more services is hosted remote from a computer executing the application. The method can include wherein the information provided regarding one or more services is based on at least one of a context of the document, historical information regarding service usage of the user, or historical information regarding service usage of a plurality of users.

Described herein is a computer storage media storing computer-readable instructions that when executed cause a computing device to: during editing of a document, receive a trigger entry, wherein the trigger entry is based upon content added to the document; responsive to receipt of the trigger entry, provide information regarding one or more services; receive selection of a service from a user; and invoke the selected service. The computer storage media can wherein the selected service is invoked by an application associated with the document. The computer storage media can further include wherein the information provided regarding one or more services is based on at least one of a context of the document, historical information regarding service usage of the user, or historical information regarding service usage of a plurality of users.

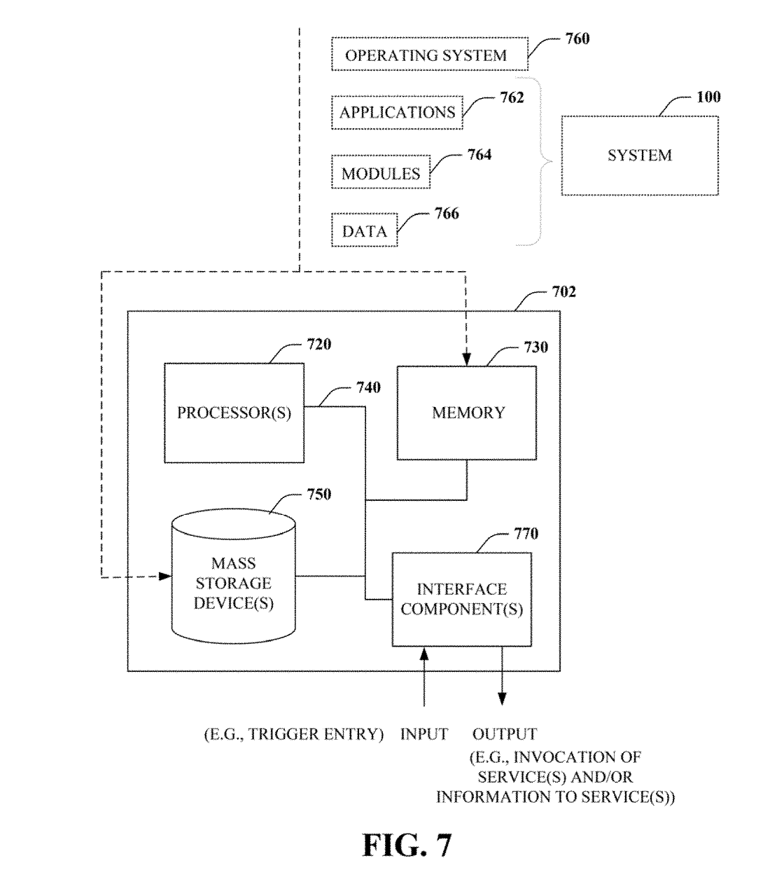

With reference to FIG. 7, illustrated is an example general-purpose computer or computing device 702 (e.g., mobile phone, desktop, laptop, tablet, watch, server, hand-held, programmable consumer or industrial electronics, set-top box, game system, compute node, etc.). For instance, the computing device 702 may be used in a system for invoking a service using a trigger entry 100.

The computer 702 includes one or more processor(s) 720, memory 730, system bus 740, mass storage device(s) 750, and one or more interface components 770. The system bus 740 communicatively couples at least the above system constituents. However, it is to be appreciated that in its simplest form the computer 702 can include one or more processors 720 coupled to memory 730 that execute various computer executable actions, instructions, and or components stored in memory 730. The instructions may be, for instance, instructions for implementing functionality described as being carried out by one or more components discussed above or instructions for implementing one or more of the methods described above.

The processor(s) 720 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 720 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 720 can be a graphics processor.

The computer 702 can include or otherwise interact with a variety of computer-readable media to facilitate control of the computer 702 to implement one or more aspects of the claimed subject matter. The computer-readable media can be any available media that can be accessed by the computer 702 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 702. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 730 and mass storage device(s) 750 are examples of computer-readable storage media. Depending on the exact configuration and type of computing device, memory 730 may be volatile (e.g., RAM), non-volatile (e.g., ROM, flash memory, etc.) or some combination of the two. By way of example, the basic input/output system (BIOS), including basic routines to transfer information between elements within the computer 702, such as during start-up, can be stored in nonvolatile memory, while volatile memory can act as external cache memory to facilitate processing by the processor(s) 720, among other things.

Mass storage device(s) 750 includes removable/non-removable, volatile/non-volatile computer storage media for storage of large amounts of data relative to the memory 730. For example, mass storage device(s) 750 includes, but is not limited to, one or more devices such as a magnetic or optical disk drive, floppy disk drive, flash memory, solid-state drive, or memory stick.

Memory 730 and mass storage device(s) 750 can include, or have stored therein, operating system 760, one or more applications 762, one or more program modules 764, and data 766. The operating system 760 acts to control and allocate resources of the computer 702. Applications 762 include one or both of system and application software and can exploit management of resources by the operating system 760 through program modules 764 and data 766 stored in memory 730 and/or mass storage device (s) 750 to perform one or more actions. Accordingly, applications 762 can turn a general-purpose computer 702 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 762, and include one or more modules 764 and data 766 stored in memory and/or mass storage device(s) 750 whose functionality can be realized when executed by one or more processor(s) 720.

In accordance with one particular embodiment, the processor(s) 720 can correspond to a system on a chip (SOC) or like architecture including, or in other words integrating, both hardware and software on a single integrated circuit substrate. Here, the processor(s) 720 can include one or more processors as well as memory at least similar to processor(s) 720 and memory 730, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 702 also includes one or more interface components 770 that are communicatively coupled to the system bus 740 and facilitate interaction with the computer 702. By way of example, the interface component 770 can be a port (e.g., serial, parallel, PCMCIA, USB, FireWire, etc.) or an interface card (e.g., sound, video, etc.) or the like. In one example implementation, the interface component 770 can be embodied as a user input/output interface to enable a user to enter commands and information into the computer 702, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 770 can be embodied as an output peripheral interface to supply output to displays (e.g., LCD, LED, plasma, etc.), speakers, printers, and/or other computers, among other things. Still further yet, the interface component 770 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system for invoking a service using a trigger entry, comprising:
a computer comprising a processor and a memory having computer-executable instructions stored thereupon which, when executed by the processor, cause the computer to:
during editing of a document, receive the trigger entry, wherein the trigger entry is based upon content added to the document;
responsive to receipt of the trigger entry, provide information regarding one or more services;
receive selection of a service from a user; and
invoke the selected service.

2. The system of claim 1, wherein invoke the selected service comprises embedding an object into the document, the object comprising code for communicating with the selected service.

3. The system of claim 1, wherein receive the trigger entry comprises receive a character, symbol, or sequence of characters designed as the trigger entry.

4. The system of claim 1, wherein the selected service is invoked by an application associated with the document.

5. The system of claim 1, wherein invoke the selected service comprises an application associated with the document provides information from the selected service to the user.

6. The system of claim 1, wherein invoke the selected service comprises an application associated with the document provides information received from the user to the selected service.

7. The system of claim 1, wherein at least one of the one or more services is local to the computer.

8. The system of claim 1, wherein at least one of the one or more services is hosted remote from the computer.

9. The system of claim 1, wherein the information provided regarding one or more services is based on at least one of a context of the document, historical information regarding service usage of the user, or historical information regarding service usage of a plurality of users.

10. A method of invoking a service using a trigger entry, comprising:
during editing of a document, receiving the trigger entry, wherein the trigger entry is based upon content added to the document;
responsive to receipt of the trigger entry, providing information regarding one or more services;
receiving selection of a service from a user; and
invoking the selected service.

11. The method of claim 10, wherein receive the trigger entry comprises receive a character, symbol, or sequence of characters designed as the trigger entry.

12. The method of claim 10, wherein the selected service is invoked by an application associated with the document.

13. The method of claim 12, wherein invoking the selected service comprises the application associated with the document providing information from the selected service to the user.

14. The method of claim 12, wherein invoking the selected service comprises the application associated with the documents providing information received from the user to the selected service.

15. The method of claim 12, wherein at least one of the one or more services is local to a computer executing the application.

16. The method of claim 12, wherein at least one of the one or more services is hosted remote from a computer executing the application.

17. The method of claim 10, wherein the information provided regarding one or more services is based on at least one of a context of the document, historical information regarding service usage of the user, or historical information regarding service usage of a plurality of users.

18. A computer storage media storing computer-readable instructions that when executed cause a computing device to:
during editing of a document, receive a trigger entry, wherein the trigger entry is based upon content added to the document;
responsive to receipt of the trigger entry, provide information regarding one or more services;
receive selection of a service from a user; and
invoke the selected service.

19. The computer storage media of claim 18, wherein the selected service is invoked by an application associated with the document.

20. The computer storage media of claim 18, wherein the information provided regarding one or more services is based on at least one of a context of the document, historical information regarding service usage of the user, or historical information regarding service usage of a plurality of users.
